(19) United States
(12) Patent Application Publication
(10) Pub. No.: US 2026/0148152 A1
(43) Pub. Date: May 28, 2026

(54) SOLAR PANEL INSTALLATION ROBOT AND FLEET MANAGEMENT

(71) Applicant: Cosmic Robotics, Inc., San Francisco, CA (US)

(72) Inventors: James Emerick, San Francisco, CA (US); Lewis Jones, San Francisco, CA (US); James Yang, San Francisco, CA (US); Andrew Zellman, Berkeley, CA (US); Elizabeth Olson, San Jose, CA (US); Giacomo Taylor, San Francisco, CA (US)

(21) Appl. No.: 19/400,000

(22) Filed: Nov. 25, 2025

Related U.S. Application Data
(60) Provisional application No. 63/725,893, filed on Nov. 27, 2024.

(51) Int. Cl. G06Q 10/0631; G05D 1/617; G05D 1/622; G05D 1/69; G05D 107/90

(52) U.S. Cl. CPC G06Q 10/06311; G05D 1/621; G05D 1/622; G05D 1/69; G05D 2107/90

(57) ABSTRACT

An automation system manages operations of a fleet of robotic devices at a construction site. The system receives a construction plan including site data and a list of tasks with dependencies. Based on the plan, the system generates a virtual representation of the construction site and allocates tasks to individual robotic devices. Each robotic device transmits operational status data and sensor data, which is received by the system and used to update the virtual representation. The updated representation reflects the status of each task and incorporates real-time site information. The system generates a visualization of the virtual representation and transmits it to a client device operated by a user, causing the visualization to be presented on the client device.

### CROSS REFERENCE TO RELATED APPLICATION

This application claims the benefit of priority to U.S. Provisional Patent Application No. 63/725,893, filed on Nov. 27, 2024, which is hereby incorporated by reference in its entirety.

### TECHNICAL FIELD

The present disclosure generally relates to automation systems, and more specifically to automation systems for construction and maintenance operations in large-scale solar farms.

### BACKGROUND

Large-scale solar farm projects face significant operational challenges during construction and maintenance. Utility-scale installations often require the handling and precise placement of hundreds of thousands, or even millions, of solar panels—along with the associated racking, support structures, and electrical components—across extensive and often uneven sites.

Transporting heavy materials from central drop-off points to installation zones requires sustained effort and coordination, while safety hazards, weather-related disruptions, and site accessibility issues further complicate workflow.

Environmental factors exacerbate these challenges. Terrain conditions can vary across the site, with obstacles, debris, or water accumulation restricting access. Weather changes—dust, glare, fog, and fluctuating lighting—impact visibility and complicate the accurate alignment of components.

Maintenance operations, including inspection, cleaning, and repair, are similarly resource intensive. Without integrated data from construction, identifying faults or underperforming assets requires additional site surveys, prolonging downtime and reducing operational efficiency.

Further, manual processes for quality assurance, documentation, and asset tracking introduce inefficiencies. Such processes include (but are not limited to) recording the location, serial number, and installation details of each panel. These traditional documentation methods limit real-time visibility into project status, hampering timely decision-making.

### SUMMARY

The embodiments described herein address the above-described issues by deploying a fleet of robotic devices at a construction site and managing the fleet and construction progress using tracking data from onboard sensors. In some embodiments, a construction plan with site data and a list of tasks, including task dependencies, is received. A virtual representation of the site is generated based on the plan, and tasks are allocated to individual robots accordingly.

In some embodiments, operational status data and sensor data—such as images, GPS coordinates, LiDAR, barcode scans, or fiducial marker detections—are received from each robotic device. The virtual representation is updated in real time with task statuses and component installation progress, including determining completion of installation from images and marking tasks as complete.

In some embodiments, changes in site conditions, such as obstructions, adverse weather, or restricted access, trigger updates to the construction plan and task reallocation. Impediments detected for one robotic device can result in reassignment of tasks to another.

In some embodiments, a visualization with task progress indicators, installation maps, and timelines is generated and transmitted to an operator's device. Tasks may include installing solar panels, with tracker installation, module installation, logistics, and maintenance robotic devices performing respective functions. For panel installation, fiducial markers are used to identify and localize panels, determine their pose relative to support structures, and enable precise placement.

The embodiments described herein also enable precise localization and installation of components at a construction site using fiducial markers and computer vision. A camera mounted on a robotic device captures an image of a component affixed with a fiducial marker encoding the component's identifier. The system detects the marker in the image, extracts the identifier, and determines the component's pose—its three-dimensional position and orientation —relative to the robotic device. The pose may be calculated using a machine learning model trained with labeled images of components, with or without markers, under varied environmental conditions. Additional training images can be generated from captured data. Based on the determined pose, the robotic device positions the component at its installation location, then records and transmits the installation status to a server. A digital twin of the component can be generated, storing its pose and identifier. Fiducial markers may include AprilTag, ArUco, QR code, ChArUco, ARToolKit, data matrix, binary square, checkerboard, circular dot, or infrared-reflective types. Components can include solar panels.

### BRIEF DESCRIPTION OF THE DRAWINGS

FIG. 1 illustrates an example automation system, in which a fleet of robotic devices may be implemented, in accordance with one or more embodiments.

FIG. 2 illustrates an example solar farm construction site, in accordance with one or more embodiments.

FIG. 3 illustrates an example embodiment of a module installation robot, in accordance with one or more embodiments.

FIG. 4 illustrates an example architecture of control server, in accordance with one or more embodiments.

FIG. 5 illustrates an example architecture of a digital twin module, in accordance with one or more embodiments.

FIG. 6 illustrates an example graphical user interface at a client device for managing robotic operations in a solar farm construction site, in accordance with one or more embodiments.

FIG. 7 illustrates an example method for managing operations of a fleet of robotic devices deployed at a construction site, in accordance with one or more embodiments.

FIG. 8 illustrates an example method for localizing components at a construction site, in accordance with one or more embodiments.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

### Automation System

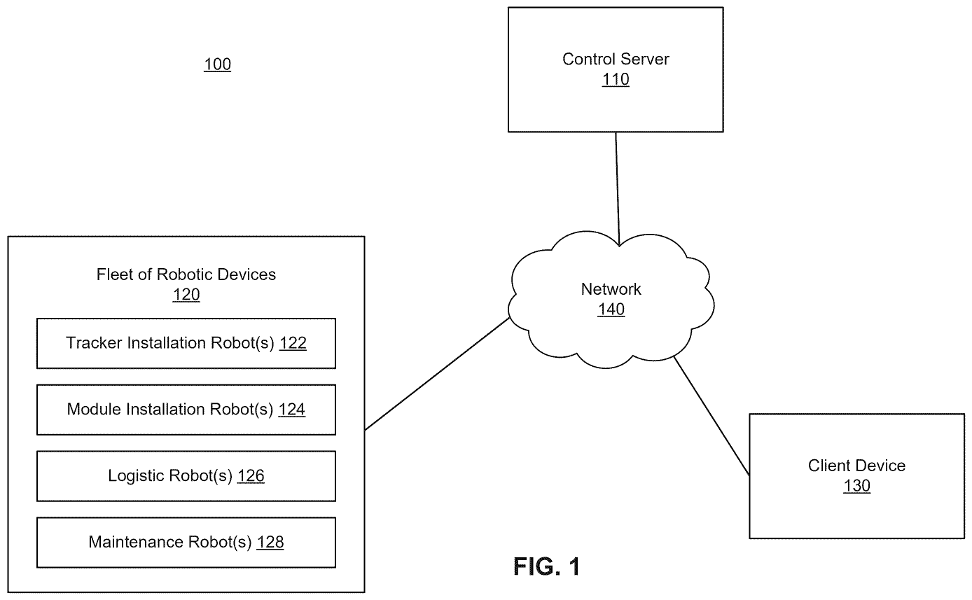

Embodiments described herein relate to automating the construction and maintenance of large-scale solar farms using a fleet of robotic devices and a centralized control platform. FIG. 1 illustrates an example automation system 100, in which a fleet of robotic devices 120 may be implemented, in accordance with one or more embodiments. In some embodiments, the fleet of robotic devices 120 include different types of robotic devices, each configured for a specific task in the solar farm construction and maintenance process. The different types of robotic devices may include (but are not limited to tracker installation robotic devices 122, module installation robotic devices 124, logistics robotic devices 126, and maintenance robotic devices 128.

The tracker installation robotic devices 122 are configured to install support structures, such as brackets and rails, which serve as the foundation for securing the solar panels. The module installation robotic devices 124 are configured to install solar panels onto the support structures. The logistics robotic devices 126 are configured to transport pallets of solar panels and other materials from centralized drop-off points to designated installation zones within the solar farm. The maintenance robotic devices 128 are configured to perform post-installation maintenance tasks, such as panel cleaning, inspection, and replacement of faulty panels, as well as supporting warranty claim documentation.

The control server 110 is configured to coordinate the robotic fleet, serving as the central hub for managing construction and maintenance activities across the solar farm. For example, the control server 110 handles various operational tasks, such as construction scheduling, task assignment, and synchronization of activities across different types of robotic devices. In some embodiments, the control server 110 causes tasks to be executed in a logical sequence, adhering to dependencies between tasks (e.g., tracker installation must be completed before module installation). In some embodiments, the control server 110 may dynamically adjust the schedule to account for real-time changes, such as delays caused by weather conditions, equipment malfunctions, or accessibility challenges.

The client device 130 is configured to communicate with the control server 110, providing users with an interface to monitor the progress of tasks in real-time. In some embodiments, the client device 130 allows users to view a detailed breakdown of ongoing activities, such as the number of solar panels installed, maintenance tasks completed, or materials transported. Users can also modify the construction schedule directly from the client device, updating priorities or rescheduling tasks as needed. For example, if a specific area becomes temporarily inaccessible, users can reprioritize tasks in unaffected zones through the interface, and the control server 110 will automatically propagate the changes to the robotic fleet.

The embodiments described herein significantly enhances solar farm construction and maintenance efficiency, and may result in several times of increase in deployment speed. The system may automate over 80% of manual labor, minimizing the need for human intervention in labor-intensive tasks such as panel installation, material transport, and routine maintenance, allowing skilled workers to focus on high-level oversight rather than physical tasks.

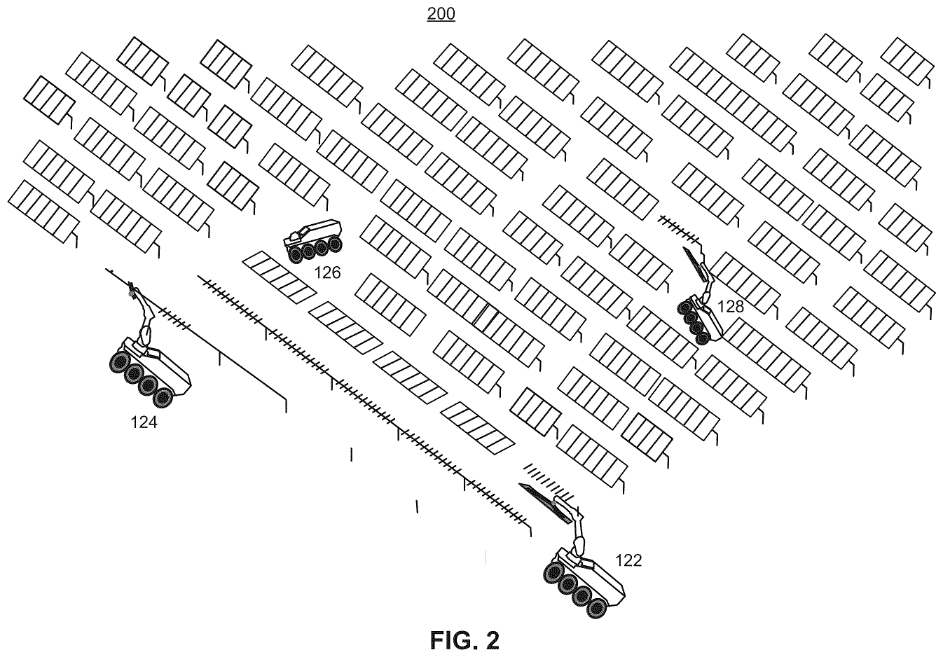

FIG. 2 illustrates an example of solar farm construction site 200, in accordance with one or more embodiments. In the construction site 200, a fleet of different robotic devices are deployed. The different robotic devices include a tracker installation robot 122, a module installation robot 124, a logistics robot 126, and a maintenance robot 128. The tracker installation robot 122 installs support structures, such as brackets and rails, which serve as the foundation for securing the solar panels. After that, the module installation robot 124 installs solar panels onto the support structures. The logistics robot 126 transports solar panels and other materials from centralized drop-off points to designated installation zones within the construction site. The maintenance robotic devices 128 performs post-installation maintenance tasks, such as panel cleaning, inspection, and replacement of faulty panels, as well as supporting warranty claim documentation.

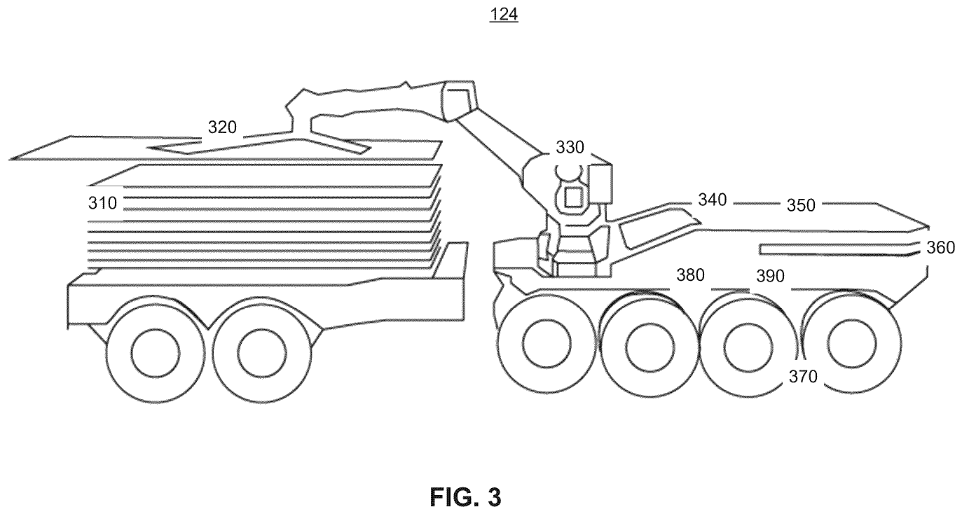

FIG. 3 illustrates an example embodiment of a module installation robot 124, in accordance with one or more embodiments. The module installation robot 124 includes a trailer 310, a vacuum gripper 320, a robotic arm 330, a pneumatic control system 340, an electronics system 350, a set of sensors 360, an all-terrain drive system 370, a battery pack 380, and an electric propulsion system 390. In various embodiments, the robot 124 may include more or fewer components than those depicted in FIG. 3.

In some embodiments, the trailer may be a high-capacity trailer capable of carrying up to 30 solar panel modules.

In some embodiments, the vacuum gripper 320 may be a ruggedized heavy-duty vacuum gripper configured to securely lift and manipulate solar panels. In some embodiments, the vacuum gripper 320 may be replaced with or augmented by other gripper modalities, such as a mechanical gripper, magnetic gripper, or electroadhesive gripper, depending on the specific requirements of the installation task. For example, a mechanical gripper may be used for solar panels with non-uniform surfaces or edges, while an electroadhesive gripper may be employed in scenarios where minimizing surface contact is advantageous.

In some embodiments, the robotic arm 330 is a six-degree-of-freedom robotic arm with a 70-kilogram lifting capacity, offering precise and flexible movements to handle solar panels or other materials during the installation process. In some embodiments, the pneumatic control system 340 may be an automotive-grade pneumatic system configured to operate robotic components.

In some embodiments, the electronics system 350 includes a set of ruggedized and field-tested electronics, such as processors and/or memory configured to control the pneumatic control system, which in term control the robotic arm 330 and vacuum gripper 320. In some embodiments, the set of sensors 360 may include stereo cameras and radar configured to detect obstacles and enable environmental awareness, which in turn enables application and training of computer vision models.

In some embodiments, the robot 124 includes autonomous navigation capabilities, allowing it to move independently across construction sites while detecting and avoiding obstacles in real-time. The set of sensors 360 can detect and locate the installation bracket, and uses a vacuum gripper 320 for secure module handling. In some embodiments, the electronics system 350 and the set of sensors 360 can also read and interpret digital site plans, executing tasks based on preprogrammed instructions or dynamically adjusting to environmental changes. In some embodiments, the robot 124 is enhanced with force-torque sensing and feedback systems to ensure safe and precise handling of panels.

In some embodiments, the all-terrain drive system 370 includes an advanced 8×8 skid steer drive system with 10-inch ground clearance, allowing the robot 124 to traverse rough and uneven terrain with ease and stability. In some embodiments, the battery pack 380 is a 35-kilowatt-hour lithium-ion battery pack configured to provide energy required to power the robot 124.

In some embodiments, the electric propulsion system 390 is a 32-horsepower electric drivetrain configured to deliver propulsion for the robot 124. In some embodiments, the propulsion system of the module installation robot 124 may include alternative propulsion types beyond the electric propulsion system 390. For instance, an internal combustion engine, a hybrid propulsion system combining electric and fuel-based components, or a hydrogen-powered system could be utilized to meet energy and operational requirements in remote or off-grid construction sites where recharging electric batteries may be challenging.

In some embodiments, robot 124 may include additional features such as real-time path planning, an all-electric drive base with full work shift capacity, interchangeable end effectors, and remote control via local or wide-area networks, making it highly versatile and reliable for automated solar installation. For example, in some embodiments, the bodies of robotic devices 122, 126, and 128 may be the same as that of robot 124, but with different end effectors. The end effector of robot 124 is a vacuum gripper, while the end effectors of robotic devices 122, 126, and 128 may include mechanical grippers, welding tools, drilling or fastening tools, adhesive applicators, cleaning brushes or jets, inspection cameras or sensor probes, material handling claws, paint or coating applicators, cutting tools, measurement or alignment tools, robotic arms with modular attachments, among others.

### Example Architecture of Control Server

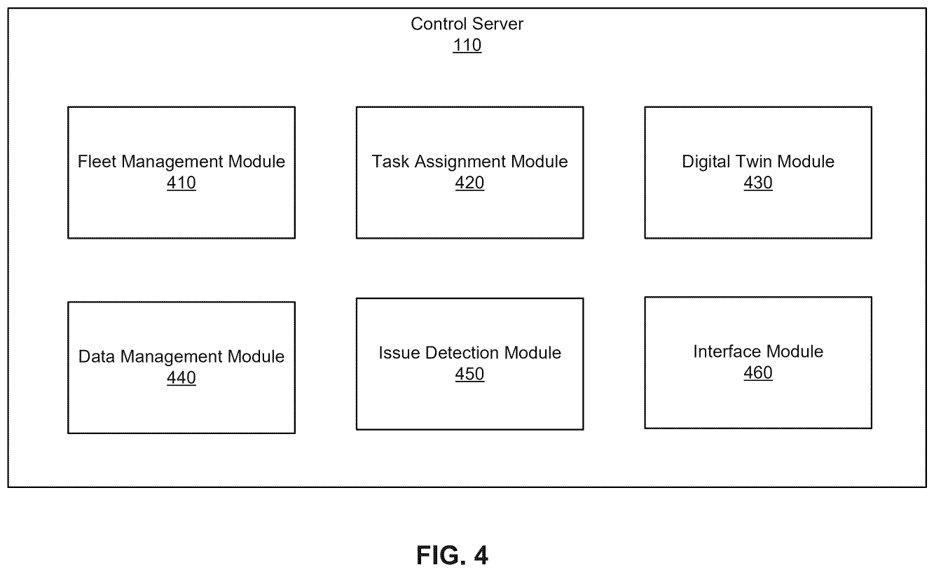

FIG. 4 illustrates an example architecture of control server 110, in accordance with one or more embodiments. The control server 110 includes a fleet management module 410, a task assignment module 420, a digital twin module 430, a data management module 440, an issue detection module 450, and an interface module 460. In various embodiments, there may be more or fewer modules as illustrated in FIG. 4. In some embodiments, functions in multiple modules may be combined in a single module; functions in a single module may be divided into multiple modules.

The fleet management module 410 is configured to monitor, track, and manage the operational status, location, and capabilities of each robotic device in the fleet. In some embodiments, the fleet management module 410 receives periodic updates from each robotic device regarding position, health status, and assigned tasks. Using this data, the fleet management module is able to maintain a synchronized view of fleet operations and enables coordinated task execution across multiple robotic devices working in different site areas.

The task assignment module 420 is configured to assign tasks to individual robotic devices or teams based on a master construction schedule and task dependencies. In some embodiments, the task assignment module 420 references a scheduling data set defining prerequisites for each task (e.g., tracker installation before module installation) and allocates resources accordingly. When real-time site conditions change, such as obstacles or delays, the task assignment module 420 can automatically reassign tasks to available robotic devices to minimize downtime.

The digital twin module 430 is configured to generate and maintain a virtual representation of the construction site, including the precise location and installation status of each solar panel, tracker, and other components. The digital twin module 430 ingests location data, sensor readings, and quality assurance information from the robotic fleet and updates the construction site model in real time. This enables operators to visualize progress, identify discrepancies, and plan maintenance activities using accurate, current data.

The data management module 440 is configured to store, organize, and make accessible the operational, quality assurance, and site condition data collected by the robotic fleet. The data management module 440 maintains a centralized database containing installation records, environmental readings, sensor logs, and media files such as images or videos. This data repository supports compliance reporting, warranty claim preparation, and analytics for improving construction efficiency.

The issue detection module 450 is configured to process incoming data from the fleet to identify issues or conditions that may impact scheduled work. Detected issues may include (but are not limited to) blocked paths, adverse weather, or equipment malfunctions. Upon detecting potential problems, the issue detection module 450 can notify operators or trigger automated schedule adjustments via the task assignment module 420.

The interface module 460 is configured to provide user access to the control server's functionality through graphical dashboards and/or control panels displayed at client devices 130. The interface module 460 enables project managers to view schedules, monitor robot status, review site maps from the digital twin, issue commands, and adjust task priorities. In some embodiments, additional communications between operators and robotic devices may also be facilitated through the interface module, including display of alerts, progress updates, and live camera feeds.

### Digital Twin

As described above, the control server 110 provides a software platform, configured to coordinate the entire robotic fleet, managing tasks like construction scheduling, task assignment, and synchronization across different robot types. In some embodiments, for each construction site, the digital twin module 430 generates a digital twin to track precise location and installation status of each solar panel and component in real time. The digital twin can maintain a record of every panel's placement and status. The digital twin can also capture geolocation data and quality checks during installation, then continue to inform maintenance activities by mapping panel efficiency and predicting failure based on observed patterns. The digital twin reduces the need for manual documentation of each panel's location and status, which is traditionally done manually by human. In some embodiments, during the installation process, the digital twin module 430 can automatically log quality checks, geolocation data, and positional accuracy information for each panel, replacing manual inspections and reducing human involvement in routine data recording.

Similarly, the maintenance robotic devices 128 automatically performs tasks such as panel cleaning, inspection, and fault detection. Each maintenance action is logged by the digital twin module 430 and stored in a central database, automatically creating a detailed maintenance history for each panel. This record-keeping simplifies compliance with warranty and regulatory requirements, minimizing the need for paperwork when filing warranty claims or tracking panel performance over time. With all data stored in a centralized database, the control server 110 can generate reports for regulatory compliance, project tracking, and client updates automatically. These reports can pull from live data, ensuring they are accurate and eliminating the need for manually compiled documents, which are both time-consuming and prone to error.

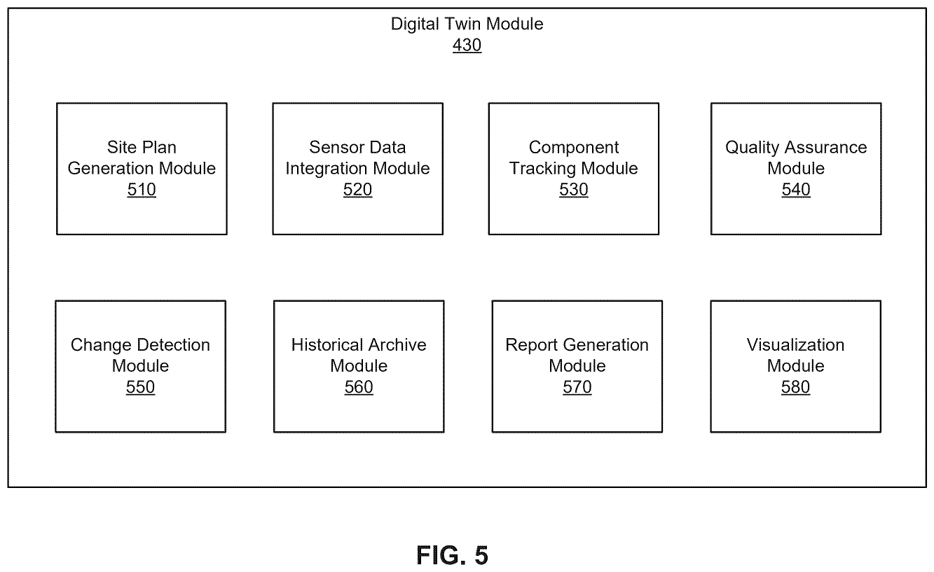

FIG. 5 illustrates an example architecture of a digital twin module 430, in accordance with one or more embodiments. The digital twin module 430 includes a site plan generation module 510, a sensor data integration module 520, a component tracking module 530, a quality assurance module 540, a change detection module 550, a historical archive module 560, a report generation module 570, and a visualization module 580. In various embodiments, there may be more or fewer modules as illustrated in FIG. 5. In some embodiments, functions in multiple modules may be combined in a single module; functions in a single module may be divided into multiple modules.

The site plan generation module 510 is configured to generate an initial virtual representation of the construction site. In some embodiments, the site plan generation module 510 imports external site plans, such as CAD drawings or GIS data, and converts them into a data structure compatible with the digital twin platform. In some embodiments, the site plan generation module 510 can synthesize a site model from topographical data collected by survey equipment.

The sensor data integration module 520 is configured to receive raw sensor inputs from the deployed robotic devices and incorporate those inputs into the digital twin. Sensor data may include GPS coordinates, camera imagery, LiDAR point clouds, or other environmental measurements. In some embodiments, the sensor data integration module 520 processes these inputs into standardized formats and updates the virtual site model to reflect observed conditions in real time.

The component tracking module 530 is configured to track the location and status of individual components, such as solar panels, racking structures, and support frames. In some embodiments, the component tracking module 530 uses identifiers such as serial numbers, barcodes, or fiducial markers scanned by the robotic devices 120 to update placement, orientation, and installation status within the digital twin.

The quality assurance module 540 is configured to log inspection results, quality control metrics, and verification data for installed components. In some embodiments, the quality assurance module 540 can associate GPS-tagged photographs, force-torque measurements, or environmental readings with specific components in the site model, providing a documented evidence trail for warranty compliance and operational audits.

The change detection module 550 is configured to compare planned site data with real-time data from the sensor and component tracking modules to identify discrepancies. These discrepancies may include misaligned installations, missing components, or environmental obstructions. Upon detecting changes, the change detection module 550 may flag affected areas in the digital twin and notify relevant operators or systems.

The historical archive module 560 is configured to maintain a time-stamped record of all site events, including installation milestones, maintenance actions, and environmental conditions. In some embodiments, the historical archive module 560 enables replay of historical states of the construction site and supports analytics for trend identification and forecasting.

The report generation module 570 is configured to compile and output reports based on data stored in the digital twin. Reports may include project progress summaries, warranty claim packages, regulatory compliance documentation, and customer status updates. In some embodiments, the report generation module 570 formats the reports in user-selected output types, such as PDF, XML, or HTML.

The visualization module 580 is configured to produce interactive graphical views of the digital twin for use on operator interfaces. In some embodiments, the visualization module 580 supports pan, zoom, and filter operations, enabling users to visually explore the construction site model, examine component-level details, and monitor real-time updates from construction site and/or the robotic fleet.

### Dynamic Task Scheduling and Reassignment

In some embodiments, the control server 110 manages scheduling by referencing a master Gantt chart which defines a sequence for tasks (e.g., a solar panel can only be installed after the racking is in place). The control server 110 also tracks dependencies between tasks, identifying situations where delays in one area might impact subsequent tasks. In some embodiments, the control server allows robotic devices to dynamically adjust tasks in response to real-time construction challenges, such as accessibility issues or weather-related delays. For example, each robot includes various sensors configured to send status updates and environmental data to the control server. This may include (but is not limited to) robot positions, task completion rates, weather conditions, ground conditions, and accessibility issues like blocked or restricted areas. The digital twin of the construction site maps the location and status of all installed components, such as solar panels, trackers, and materials. This map is updated in real time, allowing the control server to recognize any discrepancies or obstacles based on the robotic devices' feedback.

For example, when a robotic device encounters a delay or obstacle, such as a flooded zone due to rain or a pile of debris blocking access, the control server 110 can automatically reassign nearby robotic devices to tasks that are unaffected by the delay. This can minimize downtime and ensure the robotic devices remain productive, even if their original task is temporarily unachievable. As another example, in cases where a complex or unexpected delay arises, such as a widespread weather event, the control server 110 may notify human operators, who can adjust task priorities or reschedule activities based on the latest conditions. In some embodiments, operators have the option to intervene and update the digital twin to reflect new site conditions, which the robotic devices then use to adjust their own actions.

In some embodiments, by analyzing data trends from past events and current conditions, the control server 110 can anticipate potential challenges and proactively alter robot task assignments to avoid expected delays. For instance, if a specific area is prone to flooding, the control server 110 may prioritize panel installations in that zone during dry conditions or allocate materials in advance to minimize later disruption.

To achieve precise solar panel placement, the robotic devices may use tags as fiducial markers (such as April tags) on the panels, which help the installation robotic devices locate the position panels with sub-millimeter accuracy. The tags also enable efficient data collection for training computer vision models, allowing the system to improve accuracy and eventually achieve high precision even without fiducial markers.

### Training and Applying Computer Vision Models Using Fiducial Markers

In some embodiments, each solar panel or component to be installed is outfitted with a fiducial marker, which is a unique, recognizable visual tag, which may be a two-dimensional pattern similar to a QR code. These tags encode information about the component's identity and provide a reference point for localization. In some embodiments, the installation robotic devices are equipped with high-resolution cameras that detect these fiducial tags, allowing the robotic devices to locate and orient each panel with sub-millimeter accuracy. In some embodiments, the tags provide reference points that help guide the precise positioning required during the installation process, ensuring that the panels are aligned correctly and mounted securely. As the robot approaches the panel's intended location, it uses the tag's position relative to its own to fine-tune its movements. This approach enables real-time adjustments and precise alignment with the mounting structure, for achieving consistency across large solar arrays.

In some embodiments, while positioning panels, the robotic devices capture images containing both the fiducial tags and the surrounding environment. These images are stored as labeled data, where the tags provide exact ground truth coordinates and orientation information for each panel. The images can serve as training data for developing a computer vision model that can recognize and localize panels. Since the tag location is known, the system can compare the detected position with the true position based on a loss function, generating loss value. This loss value is used to train the model to predict panel positions more accurately in future tasks. In some embodiments, the fiducial tags act as ground truth markers during the model's training phase. The system uses them to measure the accuracy of the model's predictions, helping to adjust parameters of the model iteratively until it achieves high precision in locating panels based on raw image data alone.

Over time, as the computer vision model becomes more accurate, the system relies less on fiducial tags for precise positioning. The trained model, now capable of recognizing and localizing panels based on visual features of components alone, enables the system to place panels with high precision without the need for fiducial markers. The model learns to detect and utilize other visual cues in the construction environment, such as the shapes of mounting structures, edges of panels, and background textures. This improves flexibility and reduces setup time, as operators no longer need to affix tags to every panel. In some embodiments, the training dataset may be collected under various lighting and environmental conditions, such that the computer vision model is trained to function accurately under various lighting and environmental conditions to provide the system with the adaptability needed for dynamic outdoor construction settings

By developing a robust computer vision model capable of operating without fiducial markers, the system becomes more scalable and adaptable, allowing for rapid deployment across diverse construction sites.

In some embodiments, even after moving away from fiducial markers, the computer vision system continues to monitor and refine positioning data, which can be utilized to retrain and fine-tune the model for enhanced performance. For example, in some embodiments, the system 100 may collect data from scenarios where the model operates without fiducial tags. This data may include video or image recordings of the environment and tasks, positional feedback or corrections applied by the system 100 during operations, and performance metrics such as alignment errors or success cases. The newly collected data can then be incorporated into the training dataset to retrain and fine-tune the computer vision model.

In some embodiments, emergency stop (E-stop) signals and other critical communications between the operator controller and the robotic device 120 may be implemented using direct point-to-point radio communication rather than relying on a network. This approach ensures that high-priority safety commands, such as stopping a robot during an emergency, are transmitted with minimal latency and are not dependent on the availability or reliability of the network infrastructure. The system 100 may utilize robust radio communication protocols designed to operate effectively in challenging environments, such as those with interference or limited connectivity, ensuring the operator retains control over the robotic device in all scenarios. These safety-critical communication pathways are designed to function independently of the centralized control server to prioritize immediate action when necessary.

### Example Graphical User Interface

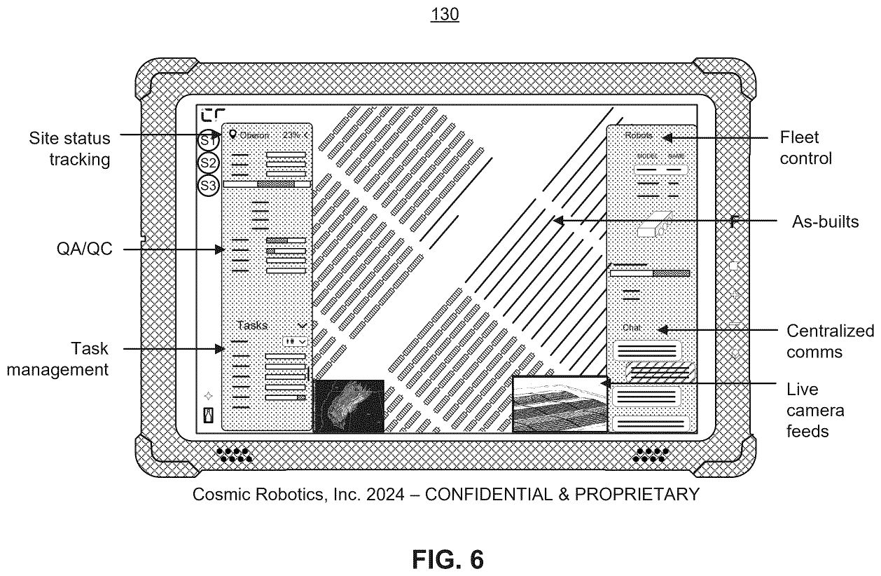

FIG. 6 illustrates an example graphical user interface at a client device 130 for managing robotic operations in a solar farm construction site, in accordance with one or more embodiments. The interface includes multiple functional sections, including site status tracking, quality assurance/quality control (QA/QC), task management, fleet control, as-builts, centralized communication, and live camera feeds.

The site status tracking function provides a view of the current status of various site sections, such as progress update, completed tasks, and area requiring attention. QA/QC function provides a view of quality-related information, such as inspection results, verification of completed tasks, and/or any flagged issues that require corrective action. In some embodiments, the QA/QC function is automatically performed during the installation process. For instance, as part of the module installation, the system may capture GPS-location records to log the precise position of each panel, compare the placement with the site plan, and document before-and-after photos of the module installation. Additionally, the system may record force-torque readings to verify proper handling and secure attachment during installation. In some embodiments, all or part of this data can be integrated into the digital twin application, creating a comprehensive record of each panel's installation. This automated QA/QC process ensures quality assurance is embedded into the workflow, reduces the need for manual checks, and provides a detailed history for maintenance or compliance purposes.

Task management function provides a view of tasks assigned to different robotic devices or teams, task priorities, tasks' statuses (e.g., in progress, completed, or pending), and other actionable items. Fleet control function provides control and monitoring options for operators to view individual robot statuses, operational modes, and assignments. As-builds function provides a view of as-built plans, showing the current state of installed components (e.g., solar panels, trackers) compared to the initial site plans. The centralized communications function enables operators and team members to exchange update, report issues, and coordinate activities. Notifications and alerts related to system operations may also be displayed here. Live camera feeds function provides real-time video feeds from cameras integrated with the robotic devices or installed at various locations across the site. This helps operators visually monitor on-site activities and resolve issues quickly.

### Example Methods for Fleet Management

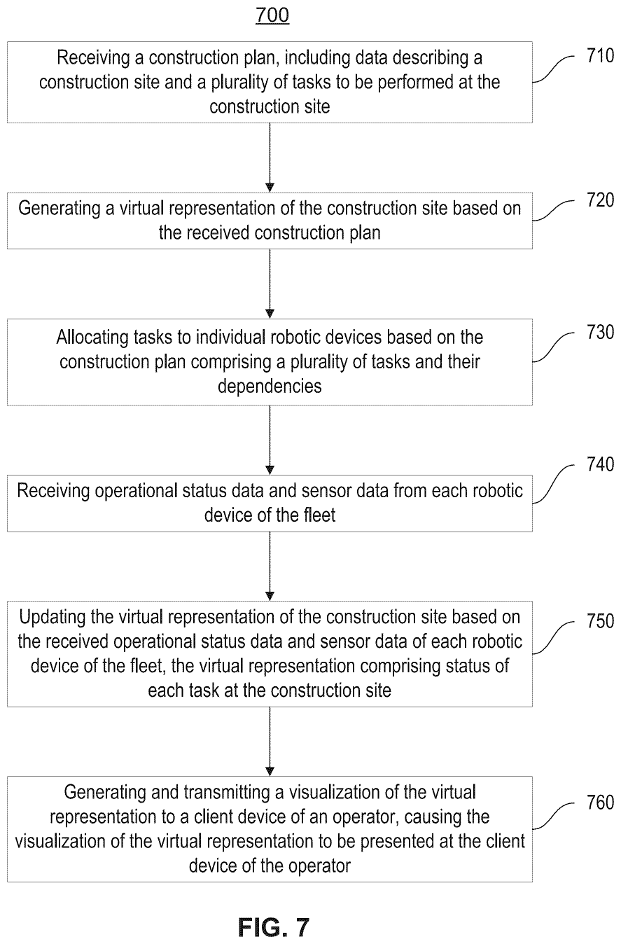

FIG. 7 illustrates an example method 700 for managing operations of a fleet of robotic devices deployed at a construction site, in accordance with one or more embodiments. The method 700 may be performed by a system, which may include a control server (e.g., control server 110), a client device (e.g., client device 130), and/or one or more robotic devices (e.g., fleet of robotic devices 120). In various embodiments, the method 700 may include additional or fewer steps, and the steps may be performed in different orders as those depicted in FIG. 7.

The system receives 710 a construction plan, including data describing a construction site and a plurality of tasks to be performed at the construction site. The construction plan may include detailed descriptions of work areas, physical boundaries, access points, topographic information, and environmental conditions. Task data can comprise step-by-step sequences with dependencies, resource requirements, and completion criteria. This serves as the foundation for scheduling, allocating robotic resources, and initializing operational monitoring for the entire construction process.

The system generates 720 a virtual representation of the construction site based on the received construction plan. This virtual representation is a digital model of the site, which may be constructed from CAD drawings, GIS data, or similar sources, which visually and structurally maps the layout of components, work zones, and pathways. The model reflects the planned layout prior to work commencing and is configured to be dynamically updated as work progress data is received, enabling accurate status tracking and coordination.

The system allocates 730 tasks to individual robotic devices based on the construction plan comprising a plurality of tasks and their dependencies. Allocation may be performed according to each robot's capability, location, and availability, while respecting prerequisite relationships between tasks. The process can be automated by software modules or assisted by human operators via the control interface. Tasks may be delivered as machine-readable work orders containing positional targets, execution parameters, and safety constraints.

The system receives 740 operational status data and sensor data from each robotic device of the fleet. Operational status data may include (but is not limited to) current task stages, functional states, error codes, or downtime notifications. Sensor data may include environmental measurements, imagery, GPS readings, LiDAR point clouds, barcode scans, and fiducial marker detections. This data is transmitted over wired or wireless communication channels at defined intervals or in real time to the control server.

The system updates 750 the virtual representation of the construction site based on the received operational status data and sensor data of each robotic device of the fleet, the virtual representation comprising status of each task at the construction site. Updates can involve marking completed tasks, showing in-progress activities, identifying delayed or impeded work, and incorporating precise component placement data. The representation may highlight deviations from the plan and record site-specific changes identified by the fleet.

The system generates and transmits 760 a visualization of the virtual representation to a client device of an operator, causing the visualization of the virtual representation to be presented at the client device of the operator. This visualization may be an interactive dashboard showing site maps, task timelines, robot positions, and component installation progress. The client device may be a tablet, laptop, or other interface that enables the operator to filter views, zoom into specific work areas, and issue updated task instructions directly from the displayed model.

### Example Methods for Localizing Components

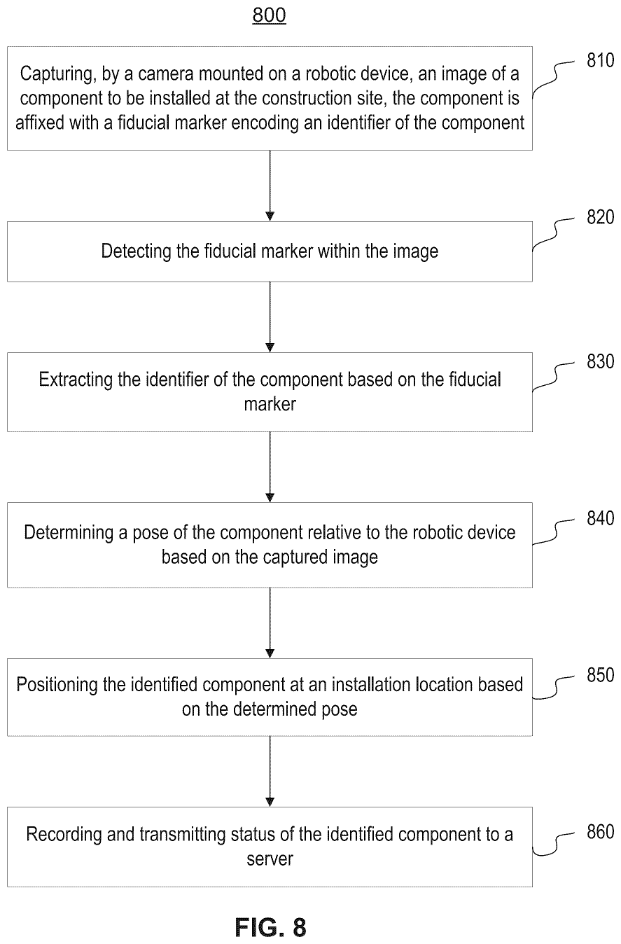

FIG. 8 illustrates an example method 800 for localizing components at a construction site, in accordance with one or more embodiments. The method 800 may be performed by a system, which may include a control server (e.g., control server 110), a client device (e.g., client device 130), and/or one or more robotic devices (e.g., fleet of robotic devices 120). In various embodiments, the method 800 may include additional or fewer steps, and the steps may be performed in different orders as those depicted in FIG. 8.

A camera mounted on a robotic device captures 810 an image of a component to be installed at the construction site, the component is affixed with a fiducial marker encoding an identifier of the component. The camera may be a high-resolution, machine vision camera positioned to obtain a clear view of the component during handling or approach. The fiducial marker may be printed, engraved, or otherwise attached to the component in a location that is visible to the camera under typical installation conditions. The fiducial marker may be at least one of: an AprilTag marker, an ArUco marker, a QR code, a ChArUco code, an ARToolKit marker, a data matrix code, a binary square marker, a checkerboard pattern, circular dot pattern, or an infrared-reflective marker. The captured image includes both the physical visual features of the component and the graphic pattern of the fiducial marker, enabling subsequent detection and decoding steps. In some embodiments, the construction site is a solar farm, and the component is a solar panel that is to be installed in the solar farm.

The robotic device detects 820 the fiducial marker within the image. Detection is performed using image processing algorithms capable of identifying the predefined geometric or coded pattern of the fiducial marker within the captured frame. In some embodiments, the detection step includes preprocessing operations such as filtering, contrast enhancement, or edge detection to improve marker visibility under varying light and environmental conditions at the construction site.

The robotic device extracts 830 the identifier of the component based on the fiducial marker. Once the marker is detected, decoding routines interpret the encoded data in the marker to obtain the unique identifier assigned to the component. This identifier may include serial numbers, batch codes, or other alphanumeric identifiers used to track the specific component in site records or a digital twin representation. The extraction step ensures accurate association between the physical component being installed and its digital record.

The system determines 840 a pose of the component relative to the robotic device based on the captured image. Pose determination includes calculating the spatial position and orientation of the component with respect to the robot's reference frame. In some embodiments, the pose is calculated by analyzing the spatial relationship between the fiducial marker and the camera's optical axis, using known marker dimensions and geometry. This computed pose may account for six degrees of freedom, enabling precise alignment of the component during installation. In some embodiments, the robotic device is equipped with a GPS configured to determine its location and pose in real-world coordinates. Using its location and pose together with the relative pose of the component, the robotic device can calculate the component's location and pose in real-world coordinates.

The robotic device positions 850 the identified component at an installation location based on the determined pose. Using the calculated position and orientation, the robotic device generates movement commands for actuators such as robotic arms or end effectors to align and place the component into its intended installation position. This step may involve fine adjustments in response to feedback from sensors to ensure the component is correctly oriented and securely fitted to the installation structure.

The robotic device records and transmits 860 status of the identified component to a server. Status data may include confirmation of installation, final pose coordinates, timestamp, and quality assurance metrics such as placement accuracy or detected defects. This data is sent via a communication interface to a central server, where it can be stored in a project database, integrated into a digital twin of the construction site, or used for progress tracking, reporting, and future maintenance planning.

### Additional Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which include any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for managing operations of a fleet of robotic devices deployed at a construction site, the method comprising:
receiving a construction plan, including data describing a construction site and a plurality of tasks to be performed at the construction site;
generating a virtual representation of the construction site based on the received construction plan;
allocating tasks to individual robotic devices based on the construction plan comprising a plurality of tasks and their dependencies;
receiving operational status data and sensor data from each robotic device of the fleet; and
updating the virtual representation of the construction site based on the received operational status data and sensor data of each robotic device of the fleet, the virtual representation comprising status of each task at the construction site; and
generating and transmitting a visualization of the virtual representation to a client device of an operator, causing the visualization of the virtual representation to be presented at the client device of the operator.

2. The method of claim 1, wherein the sensor data from the robotic devices includes at least one of image data, GPS coordinates, LiDAR point clouds, barcode scans, or fiducial marker detections.

3. The method of claim 1, wherein the sensor data includes an image of a component being installed, and updating the virtual representation comprises a virtual representation of the component being installed.

4. The method of claim 3, further comprising:
determining whether installation of the component is completed based on images of the component received from one or more robotic devices; and
in response to determining that the installation of the component is complete, updating status of the virtual representation of the component as installed.

5. The method of claim 1, further comprising:
determining whether condition of the construction site is changed;
in response to determining that the condition of the construction site is changed,
updating the construction plan; and
updating allocation of the tasks to individual robotic devices based on the updated construction plan.

6. The method of claim 5, wherein determining that the condition of the construction site is changed comprises determining that a path or location at the construction site is obstructed due to an obstacle, adverse weather, or restricted access.

7. The method of claim 1, further comprising:
detecting an impediment to execution of a task by a first robotic device; and
reassigning that task to a second robotic device based on the virtual representations of the first robotic device and the second robotic device.

8. The method of claim 1, wherein the visualization includes task progress indicators and component installation maps.

9. The method of claim 1, wherein the visualization includes a timeline view of tasks, the timeline view updating automatically when tasks are reassigned or when impediments are resolved.

10. The method of claim 1, wherein the tasks include installing one or more solar panels on support structures within the construction site, and
wherein the robotic devices includes:
at least one tracker installation robot configured to install support structures to support solar panels;
at least one module installation robot configured to install solar panel modules onto the support structures;
at least one logistic robot configured to transport materials within the construction site; and
at least one maintenance robot configured to perform post-installation maintenance tasks for the solar panels.

11. The method of claim 10, wherein installing solar panels on support structures comprises:
detecting, by the at least one installation robot, a fiducial marker attached to a solar panel, wherein the fiducial marker encodes information for identifying and localizing the solar panel;
determining, by the at least one installation robot, a pose of the solar panel relative to a support structure based on the detected fiducial marker; and
installing, by the at least one installation robot, the solar panel on racking structures based on the determined pose of the solar panel.

12. A non-transitory computer readable medium, encoded thereon, computer-readable instructions that when executed by one or more processors, cause the one or more processors to perform steps comprising:
receiving a construction plan, including data describing a construction site and a plurality of tasks to be performed at the construction site;
generating a virtual representation of the construction site based on the received construction plan;
allocating tasks to individual robotic devices based on the construction plan comprising a plurality of tasks and their dependencies;
receiving operational status data and sensor data from each robotic device of a fleet; and
updating the virtual representation of the construction site based on the received operational status data and sensor data of each robotic device of the fleet, the virtual representation comprising status of each task at the construction site; and
generating and transmitting a visualization of the virtual representation to a client device of an operator, causing the visualization of the virtual representation to be presented at the client device of the operator.

13. The non-transitory computer readable medium of claim 12, wherein the sensor data from the robotic devices includes at least one of image data, GPS coordinates, LiDAR point clouds, barcode scans, or fiducial marker detections.

14. The non-transitory computer readable medium of claim 12, wherein the sensor data includes an image of a component being installed, and updating the virtual representation comprises a virtual representation of the component being installed.

15. The non-transitory computer readable medium of claim 14, further comprising:
determining whether installation of the component is completed based on images of the component received from one or more robotic devices;
in response to determining that the installation of the component is complete, updating status of the virtual representation of the component as installed.

16. The non-transitory computer readable medium of claim 12, further comprising:
determining whether condition of the construction site is changed;
in response to determining that the condition of the construction site is changed,
updating the construction plan; and
updating allocation of the tasks to individual robotic devices based on the updated construction plan.

17. The non-transitory computer readable medium of claim 16, wherein determining that the condition of the construction site is changed comprises determining that a path or location at the construction site is obstructed due to an obstacle, adverse weather, or restricted access.

18. The non-transitory computer readable medium of claim 12, wherein the tasks include installing one or more solar panels on support structures within the construction site, and
wherein the robotic devices includes:
at least one tracker installation robot configured to install support structures to support solar panels;
at least one module installation robot configured to install solar panel modules onto the support structures;
at least one logistic robot configured to transport materials within the construction site; and
at least one maintenance robot configured to perform post-installation maintenance tasks for the solar panels.

19. The non-transitory computer readable medium of claim 18, wherein installing solar panels on support structures comprises:
detecting, by the at least one installation robot, a fiducial marker attached to a solar panel, wherein the fiducial marker encodes information for identifying and localizing the solar panel;
determining, by the at least one installation robot, a pose of the solar panel relative to a support structure based on the detected fiducial marker; and
installing, by the at least one installation robot, the solar panel on racking structures based on the determined pose of the solar panel.

20. A system, comprising:
one or more processors; and
a non-transitory computer readable medium, encoded thereon, computer-readable instructions that when executed by one or more processors, cause the one or more processors to perform steps comprising:
receiving a construction plan, including data describing a construction site and a plurality of tasks to be performed at the construction site;
generating a virtual representation of the construction site based on the received construction plan;
allocating tasks to individual robotic devices based on the construction plan comprising a plurality of tasks and their dependencies;
receiving operational status data and sensor data from each robotic device of a fleet; and
updating the virtual representation of the construction site based on the received operational status data and sensor data of each robotic device of the fleet, the virtual representation comprising status of each task at the construction site; and
generating and transmitting a visualization of the virtual representation to a client device of an operator, causing the visualization of the virtual representation to be presented at the client device of the operator.
